(19) United States
(12) Patent Application Publication
(10) Pub. No.: US 2001/0010081 A1
(43) Pub. Date: Jul. 26, 2001

(54) Terminal certification system and method of certifying the same

(76) Inventor: Kotaro Nagahama, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/765,365

(22) Filed: Jan. 22, 2001

(30) Foreign Application Priority Data
Jan. 25, 2000 (JP) 15670/2000

(51) Int. Cl. H04L 9/32

(52) U.S. Cl. 713/202

(57) ABSTRACT

A terminal certification system with a high security, which is capable of detecting and eliminating an illegal access by stealing a sender address and a password. A connection apparatus 1 and a terminal 2 stores a plurality of passwords (or a plurality of password generation algorithms) and setting information, respectively. Times of the connection apparatus 1 and the terminal 2 are made to be synchronized with each other. The password (or the password generation algorithm) is modified based on the setting information with passage of time. Thus, the password is changed. The terminal 2 adds the password to a frame to be transmitted, and transmits to the connection apparatus 1. The connection apparatus 1 compares the password of the received frame with a password of the connection apparatus 1. When the passwords are in agreement with each other, the connection apparatus 1 permits the communication of the terminal 2. When the passwords are not in agreement with each other, the connection apparatus 1 does not permit the communication of the terminal 2, and abandons the frame.

### BACKGROUND OF THE INVENTION

1. Field of the Invention

The present invention relates to a certification system of terminals connected to a system and a method of certifying the same.

2. Description of the Related Art

A conventional system is constructed in such a way that a plurality of terminals 2 are connected to a connection apparatus 1 connected to a network 4 such as LAN (Local Area Network) as shown in FIG. 17. In the conventional system, a system manager previously sets a sender address of the terminal, which is capable of accessing to the network 4, with the connection apparatus 1. The connection apparatus 1 checks the set sender address with a sender address transmitted from each terminal 2, whereby the connection apparatus 1 determines whether the terminal is the one authorized by the manager or not.

Furthermore, in another conventional system, both of the connection apparatus 1 and the terminal 2 have a specific password respectively. The terminal 2 first transmits a frame added with the specific password to the connection apparatus 1. The connection apparatus 1 checks the password of the frame with the password held by itself, whereby the connection apparatus 1 determines a possibility of a connection of the terminal 2 to the network 4.

However, in the foregoing technologies, there has been the possibility that by stealing the authorized sender address and password, an invader may make believe that the terminal 2′ is the one authorized by the manager and may connect the terminal 2′ to the connection apparatus 1. In such a case, the connection apparatus 1 determines the terminal 2′ to be authorized legally, and permits the connection of the terminal 2′ to the connection apparatus 1. For this reason, there has been a problem that the terminal 2′ connected to the network 4 illegally may establish a connection with other terminals, thus making a retention of security impossible.

### SUMMARY OF THE INVENTION

The object of the present invention is to provide a terminal certification system with a high security, which is capable of detecting illegal access and eliminating the stolen illegal access.

To solve the foregoing subjects, the terminal certification system of the present invention includes a plurality of terminals; and a connection apparatus connected to the plurality of terminals. The connection apparatus includes a password controller which changes a password with passage of time, and each of the plurality of terminals includes a password controller which changes a password with passage of time. When the terminal wishes a communication, the connection apparatus compares a password selected by a password controller of the terminal with a password selected by a password controller of the connection apparatus. If both of the passwords are in agreement with each other, the connection apparatus permits the communication.

The password controller includes a password storing memory which stores a plurality of passwords, and a password selector which selecting one of the plurality of passwords stored in the password storing memory. The password controller changes a selection of the password with passage of time.

Alternatively, the password controller includes an algorithm storing memory for storing a plurality of password generation algorithms, and a password generation element which selects one of the plurality of password generation algorithms stored in the algorithm storing memory based on the setting information with passage of time. The password generation element generates a password with the selected password generation algorithm with passage of time.

### BRIEF DESCRIPTION OF THE DRAWINGS

These and other objects, features and advantages of the invention will become more fully apparent from the following detailed description taken in conjunction with the accompanying drawings.

FIG. 1 is a block diagram showing an embodiment of a terminal certification system of the present invention;

FIG. 2 is a drawing showing a constitution of a frame used in the present invention;

FIG. 3 is a drawing showing an embodiment of a connection apparatus;

FIG. 4 is a drawing showing setting information stored in a setting memory;

FIG. 5 is a flow for explaining an operation of a frame controller of the setting apparatus;

FIG. 6 is a flow for explaining an operation of a password controller of the connection apparatus;

FIG. 7 is a drawing showing an embodiment of a terminal;

FIG. 8 is a flow for explaining an operation of a frame transmitter/receiver of the terminal;

FIG. 9 is a flow for explaining an operation of a frame assembly section of the terminal;

FIG. 10 is a flow for explaining an operation of a certification system;

FIG. 11 is a drawing showing a constitution of a frame used in a second embodiment of the present invention;

FIG. 12 is a drawing showing a constitution of a password controller of the second embodiment;

FIG. 13 is a flow for explaining an operation of the password controller;

FIG. 14 is a drawing showing a constitution of a password controller of a third embodiment of the present invention;

FIG. 15 is a drawing showing setting information stored in a setting memory of the third embodiment;

FIG. 16 is a flow for explaining an operation of a password controller; and

FIG. 17 is a block diagram showing an outline of a conventional system.

### DESCRIPTION OF THE PREFERRED EMBODIMENTS

A first embodiment of a terminal certification system of the present invention will be described with reference to the accompanying drawings below.

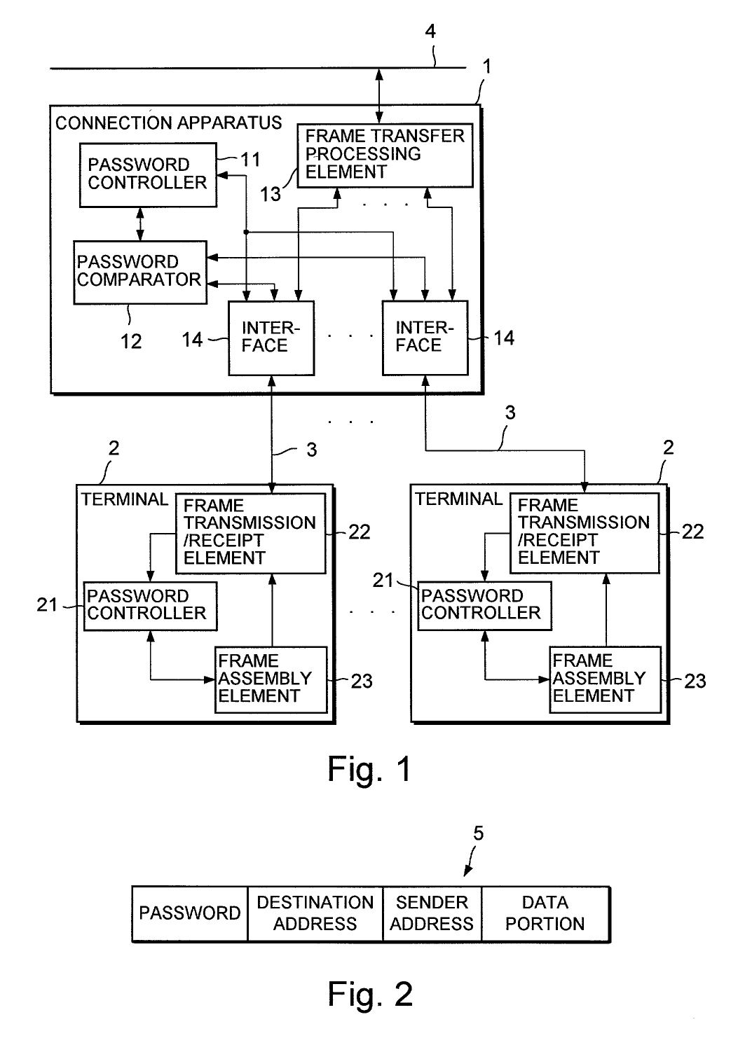

Referring to FIG. 1, the terminal certification system of the present invention includes a connection apparatus 1 connected to a network 4, and a plurality of terminals 2 connected to the connection apparatus 1. The connection apparatus 1 and each of the terminals 2 are connected through the transmission medium 3, and transmission/receipt of a frame is performed in accordance with an access method (CSMA/CD method) defined by a known standard organization IEEE802.3. Moreover, the connection apparatus 1 is connected to other connection apparatus 1 through the network 4, and controls communications among the terminals.

Note that, for example, a hub and a switch can be used as the connection apparatus 1.

The connection apparatus 1 includes a password controller 11 which generates passwords; a password comparator 12 which compares the passwords; a frame transfer processing element 13 which transmits/receives a frame to/from the network 4; and one or more interfaces 14.

The terminal 2 includes a password controller 21 which generates passwords; a frame transmission/receipt element 22 which transmits/receives a frame to/from the connecting apparatus 1; and a frame assembly element 23 which assembles the frame to be transmitted.

The password controller 11 holds the plurality of passwords, and has a function to selectively output a predetermined password among the plurality of passwords in accordance with time. Furthermore, the password controller 21 is constituted similarly to the password controller 11.

The password comparator 12 compares the password of a frame transmitted from the interface 14 and the password selected by the password controller 11 in the connection apparatus 1 with each other.

The frame transfer processing element 13 performs transmission/receipt of the frame to/from the network 4.

Moreover, the frame assembly element 23 adds the password to the frame to be transmitted to the connection apparatus 1. Referring to FIG. 2, the frame assembly element 23 assembles the frame 5 by adding the password selected by the password controller 22 to the 1 head of the frame composed of a destination address, a sender address and a data portion.

Next, descriptions for constituent components of the connection apparatus 1 and for an operation thereof will be made further in detail with reference to the drawings.

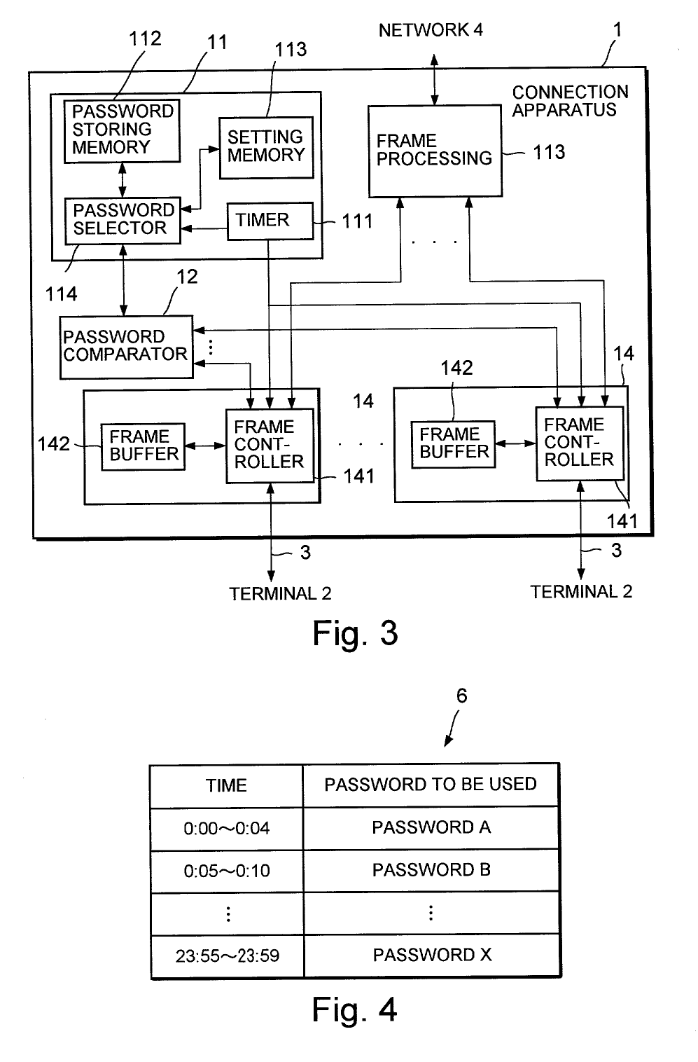

Referring to FIG. 3, the interface 14 of the connection apparatus 1 includes a frame controller 141 for transmitting/receiving the frame 5 through the transmission medium 3, and a frame buffer 142 temporarily holding the frame 5 received by the frame controller 141.

The password controller 11 includes a timer 111, a password storing memory 112, a setting memory 113 and a password selector 114. The timer 111 represents the present time in the connection apparatus 1. The password storing memory 112 stores a plural kinds of passwords. The setting memory 113 stores the setting information 6 indicating which password is used depending on time. The password selection circuit 114 selects a corresponding password from the password storing memory 112 according to the present time indicated by the timer 111 and the setting information 6.

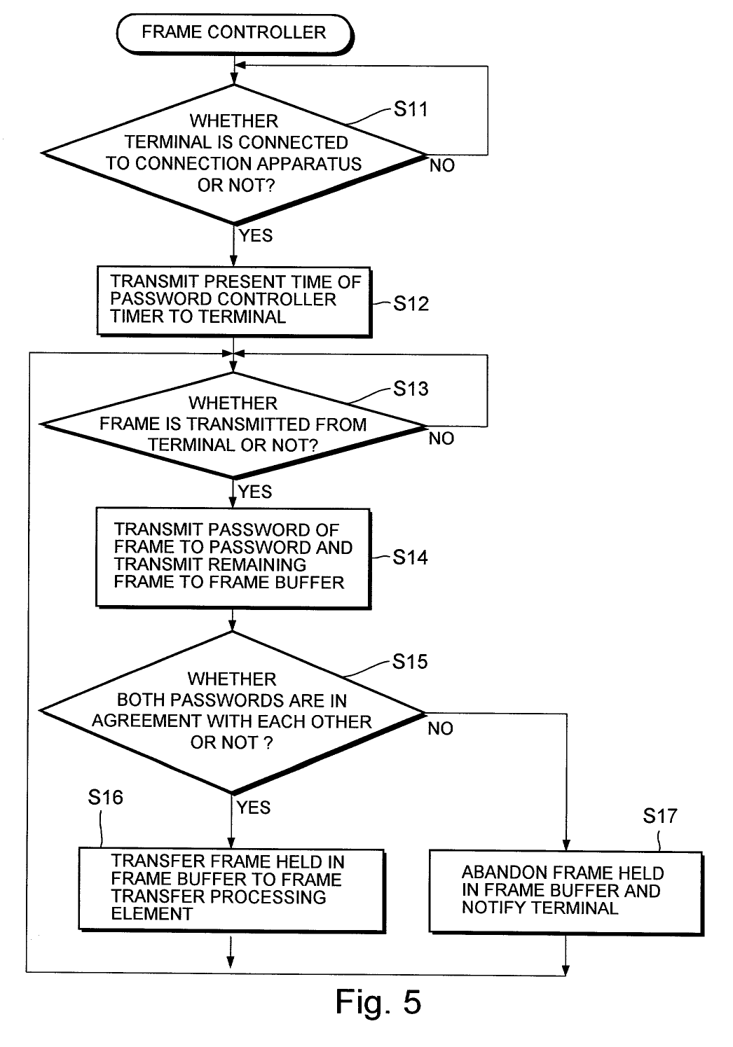

Referring to FIG. 5, the frame controller 141 of the connection apparatus 1 determines whether the terminal 2 is connected to the connection apparatus 1 or not (S11). If the connection of the terminal 2 with the connection apparatus 1 is confirmed, the frame controller 141 reads out the present time of the connection apparatus 1 from the timer 111 and transmits the present time to the terminal 2 (S12). Thereafter, the frame controller 141 monitors whether the frame is transmitted from the terminal 2 or not (S13). If the frame is transmitted from the terminal 2, the frame controller 141 transmits to the password comparator 12 the password added to the frame that was transmitted from the terminal 2, and transmits the remaining frame portion to the frame buffer 142 (S14). The password comparator 12 compares the password from the frame controller 141 with the password selected by the password selection circuit 114 (S15). As a result of the comparison, if both passwords are in agreement with each other, the frame controller 141 transfers the frame held in the frame buffer 142 to the frame transfer processing element 13 (S16). On the other hand, if both passwords are not in agreement with each other, the frame controller 141 abandons the frame held in the frame buffer 142, and notifies the terminal 2 that accesses to the network 4 cannot be allowed (S17).

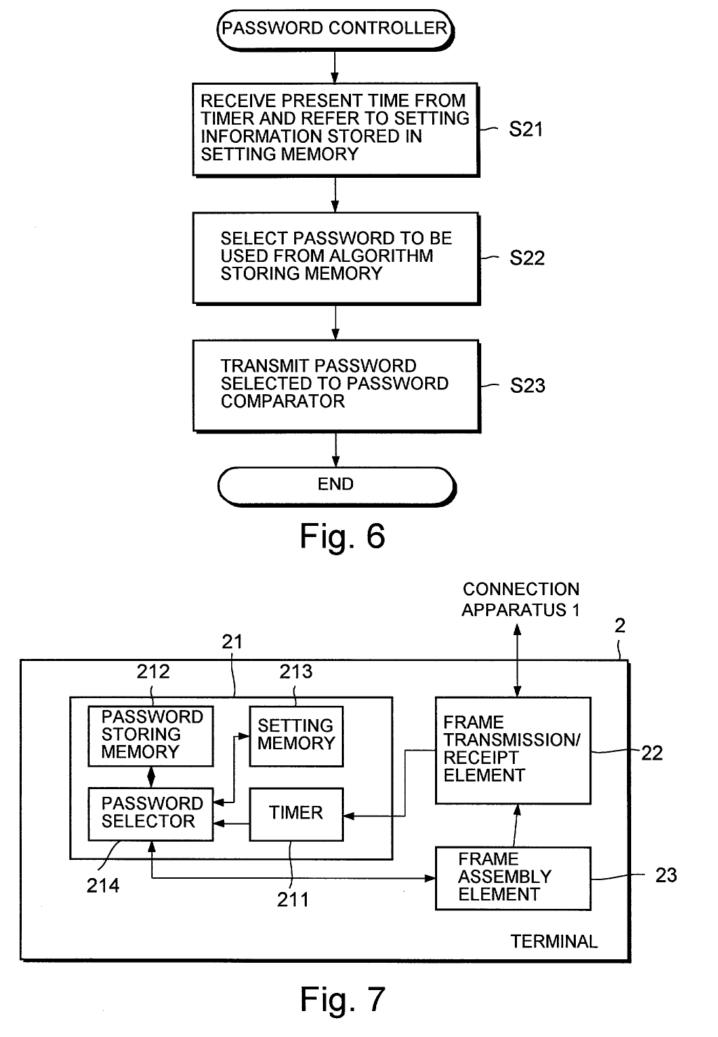

An operation of the password controller 11 will be described. Referring to FIG. 6, in the password controller 11, the password selection circuit 114 receives the present time from the timer 111, and refers to the setting information 6 stored in the setting memory 113 (S21). In accordance with the setting information 6, the password selection circuit 114 reads out from the password storing memory 112 a password to be used (S22). The password selection circuit 114 transmits the password read out to the comparator 12 (S23).

Hereupon, when a password to be selected is the same as the last password, a constitution, in which the password selection circuit 114 does not read in a password sequentially from the password storing memory 112, and the password selected in the last time is transmitted to the password comparator 12 again, may be adopted.

Furthermore, constituent components of the terminal 2 of the present invention and an operation thereof will be described more in detail using the drawing.

Referring to FIG. 7, the password controller 21 of the terminal 2 includes similarly to the password controller 11 of the connection apparatus 1 and the same contents as those stored in the password storing memory 112 and the setting memory 113 of the connection apparatus 1 are stored in the password storing memory 212 and the setting memory 213. The password selector 214 operates similarly to the password selection circuit 114 of the connection apparatus 1 shown in FIG. 6. The password selector 214 selects a corresponding password from the password storing memory under the present time indicated by the timer 211 and the setting information 6 of the setting memory 213. Only the timer 211 of the terminal 2 is different from the timer 111 of the connection apparatus 1. The timer 211 of the terminal 2 does not count the present time of the terminal 2 but counts a preset time represented by the timer 111 of the connection apparatus 1, which is transmitted from the connection apparatus 1 when the terminal 2 is connected to the connection apparatus 1.

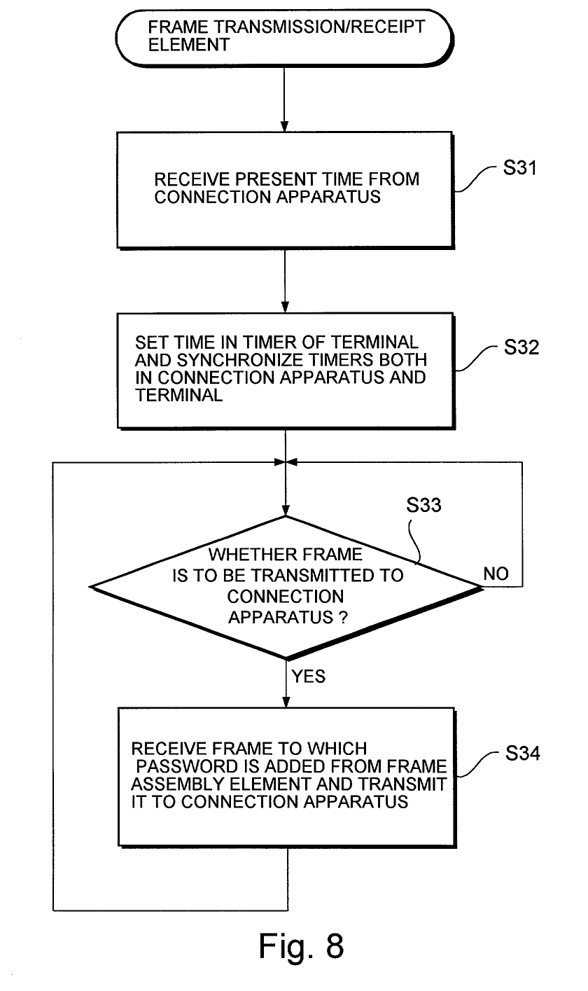

An operation of a frame transmission/receipt element 22 of the terminal 2 will be described. Referring to FIG. 8, when the terminal 2 is connected to the connection apparatus 1, the frame transmission/receipt element 22 receives the present time from the connection apparatus 1 (S31). Upon receipt of the present time of the connection apparatus 1, the frame transmission/receipt element 22 sets a time in the timer 211 of the terminal 2, and synchronizes the timers 111 and 211 (S32). After synchronizing the timers 111 and 211, if there is a frame to be transmitted to the connection apparatus 1 (S33), the frame transmission/receipt element 22 receives from the frame assembly element 23 the frame 5 to which the password shown in FIG. 3 is added, and transmits the frame 5 to the connection apparatus 1 (S34).

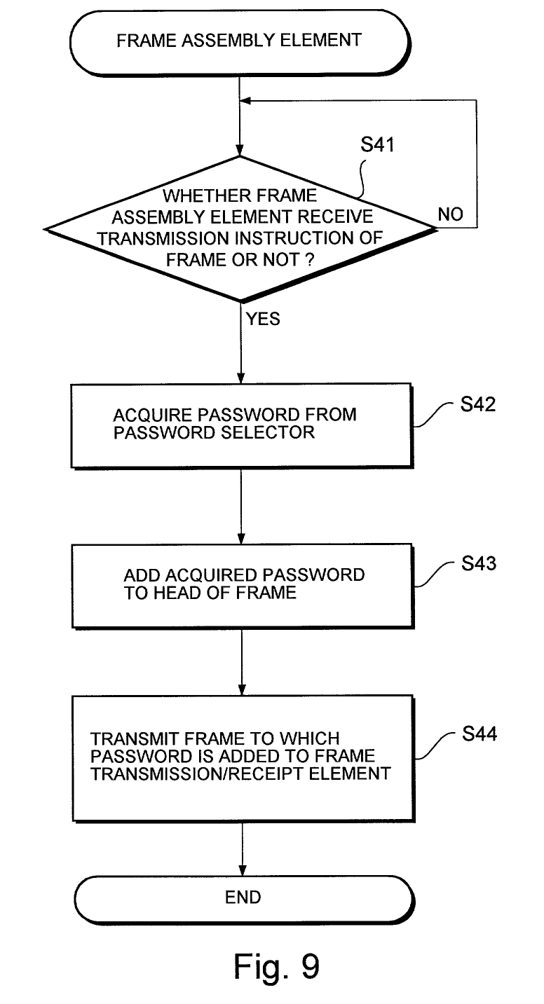

Furthermore, an operation of the frame assembly element 23 of the terminal 2 will be described. Referring to FIG. 9, the frame assembly element 23 receives an instruction of the frame transmission from a processor (not shown) (S41). The frame assembly element 23 acquires a password from the password generation section 214 (S42). The frame assembly element 23 adds the acquired password to a head of the frame composed of a destination address, a sender address and a data portion (S43). Then, the frame assembly element 23 transmits the frame 5 added the password to the frame transmission/receipt element 22 (S44).

As described above, in the present invention, the password used in the system is changed according to the present time. Accordingly, even when a certain password is leaked out by, for example, unscrambling it, the password is changed accompanied with passage of time and an illegal access is detected. Therefore, it is possible to make the access to the network unallowable, and to realize a high security of the network.

An operation of a first embodiment of the present invention will be described.

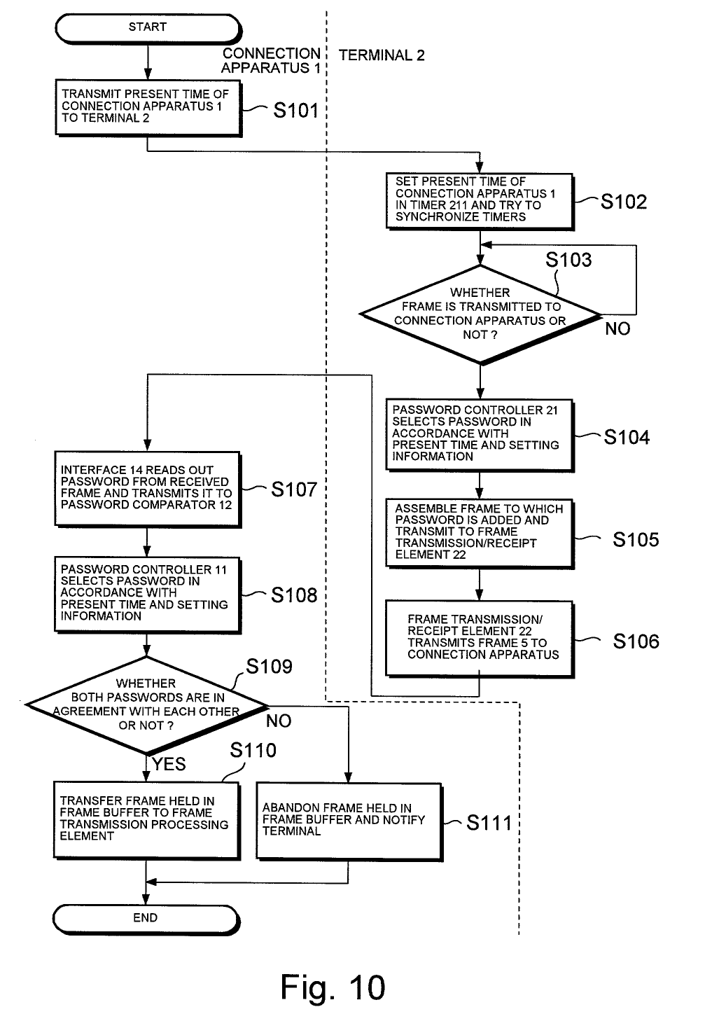

Referring to FIGS. 1 and 10, when the terminal 2 is connected to the connection apparatus 1, the present time represented by the timer 111 of the connection apparatus 1 is transmitted to the terminal 2 (S101). The frame transmission/receipt element 22 sets the transmitted time in the timer 211 and tries to synchronize the timers 111 and 211 of the connection apparatus 1 and the terminal 2 (S102). In the case where the terminal 2 performs a frame transmission such as a data transmission and an access request for the connection apparatus 1 (S103), the password controller 21 of the terminal 2 selects a password among the plurality of passwords, which is determined in accordance with the present time represented by the timer 211 (S104). The frame assembly element 23 assembles the frame 5 to which the password selected by the password controller 21 is added, and transmits the assembled password to the frame transmission/receipt element 22 (S105). The frame transmission/receipt element 22 transmits the frame 5 to the connection apparatus 1 through the transmission medium 3 (S106). After the interface 14 of the connection apparatus 1 receives the frame 5 from the terminal 2 connected thereto through the transmission medium 3, the interface 14 reads out the password from the frame 5, and then transmits the password to the password comparator 12 (S107). The password controller 11 selects a password among the plurality of passwords, which is determined in accordance with the present time represented by the timer 111 (S108). The password comparator 12 compares the password selected by the password controller 11 with the password read out from the frame 5 (S109). As a result of the comparison, if the passwords are in agreement with each other, the interface 14 determines that the terminal 2 that transmitted the frame 5 thereto is permitted to communicate with the network 4, that is, to access to the network 4. The interface 14 transmits a frame, from which the password is excluded, to the frame transmission processor 13 (S110). On the other hand, if the passwords are not in agreement with each other, the interface 14 determines that the terminal 2 are accessing to the network 4 illegally, the interface 14 makes the frame transmission to the frame transfer processor 13 unallowable, and abandons the frame, thus notifying the abandonment to the terminal 2 (S111).

Note that if the passwords are not in agreement with each other, a constitution in which retransmissions are performed by predetermined times may be adopted.

With the above described constitution, even if an illegal access is performed using a password acquired illegally, the illegal access can be found out by changing the password accompanied with passage of time determined in the setting memory 113, so that it is possible to provide a terminal certification system with a higher security.

Next, a second embodiment of the terminal certification system of the present invention will be described with reference to the drawings.

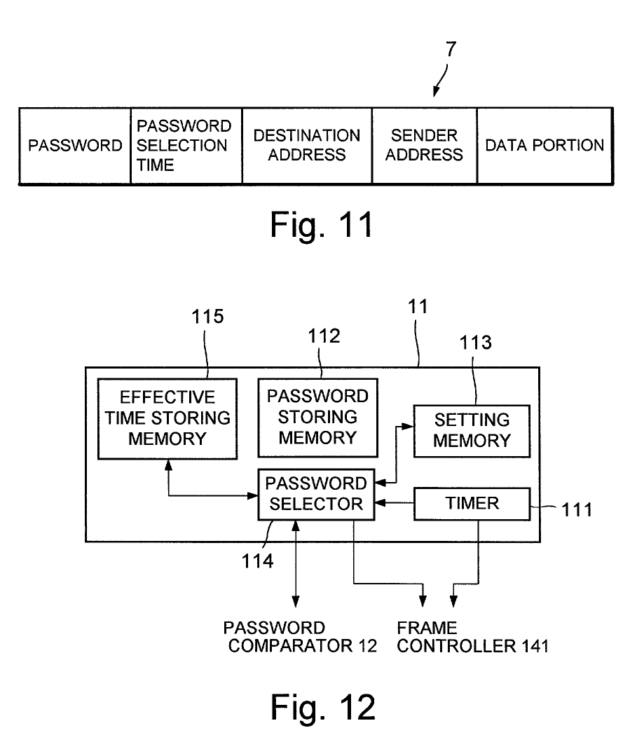

In this second embodiment, the frame assembly element 23 of the terminal 2 adds a password selection time, at which the password is selected, to the frame 7, as shown in FIG. 11. Furthermore, the connection apparatus 1 selects a password in accordance with the password selection time of the frame 7. Thus, a time difference between the password selection times generated in the connection apparatus 1 and the terminal 2 can be removed, and the accurate comparison of the passwords can be performed.

The frame controller 141 of the connection apparatus 1 operates similarly to that of the first embodiment, except that when the frame controller 141 receives the frame 7 from the terminal 2, the frame controller 141 transmits the password of the frame 7 to the password comparator 12, the password selection time to the password selection circuit 114, and the remaining portion to the frame buffer 142. Other operations of the frame controller 141 are the same as those of the first embodiment shown in FIG. 6.

However, in the case of such constitution, when the password is leaked out and the present time is accessed from the terminal 2 falsely, it is impossible to prevent the false access. Accordingly, in consideration of such circumstances, a password selection time apart from the present time of the connection apparatus 1 by more than a predetermined time is not adopted may be satisfactorily used.

In this case, referring to FIG. 12, the password controller 11 of the connection apparatus 1 further includes an effective time storing memory 115. The effective time storing memory 115 stores an effective time for judging the password selection time to be effective.

An operation of the password controller 11 of the second embodiment of the present invention will be described.

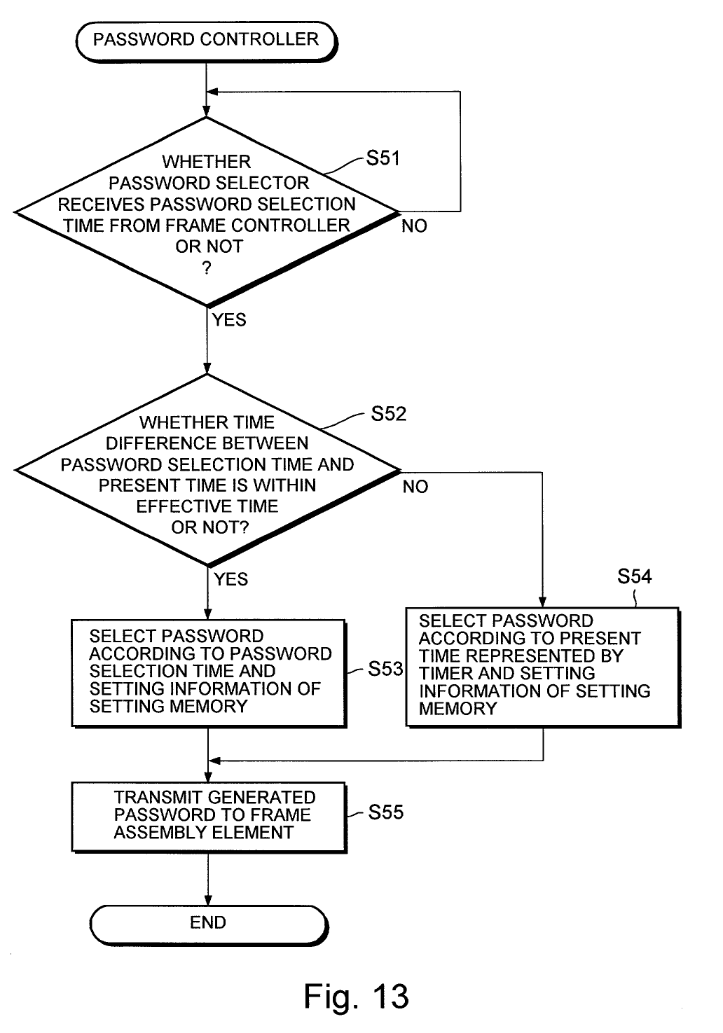

Referring to FIG. 13, the password selector 114 receives the password selection time from the frame controller 141 (S51), and then the password selection circuit 114 determines whether a time difference between the password selection time received and the present time represented by the timer 111 is within the effective time stored in the effective time storing memory 115 or not (S52). If the difference between the password selection time and the present time is within the effective time, the password selection circuit 114 selects a password to be used according to the password selection time and the setting information 6 (S53). On the other hand, if the difference between the password selection time and the present time is equal to the effective time or more, the password selector 114 does not adopt the password selection time, but selects a password to be used according to the present time represented by the timer 111 and the setting information 6 (S54). The password selection circuit 114 transmits the selected password to the password comparator 12 (S55).

With such constitution, also in communications before and after time when algorithm is changed, a situation in which different passwords are used in the connection apparatus 1 and the terminal 2 and hence the passwords are not in agreement with each other never occurs, and it is possible to realize an accurate comparison of the passwords.

Moreover, a third embodiment of the terminal certification system of the present invention will be described with reference to the drawings.

In the third embodiment of the present invention, constitutions of the password controllers 11 and 21 and operations thereof are different from those of the first embodiment. Other constituent components and operations thereof are the same as those of the first embodiment. Although the password controller 11 of the connection apparatus 1 will be hereinafter described, the same is true for the password controller 21 of the terminal 2.

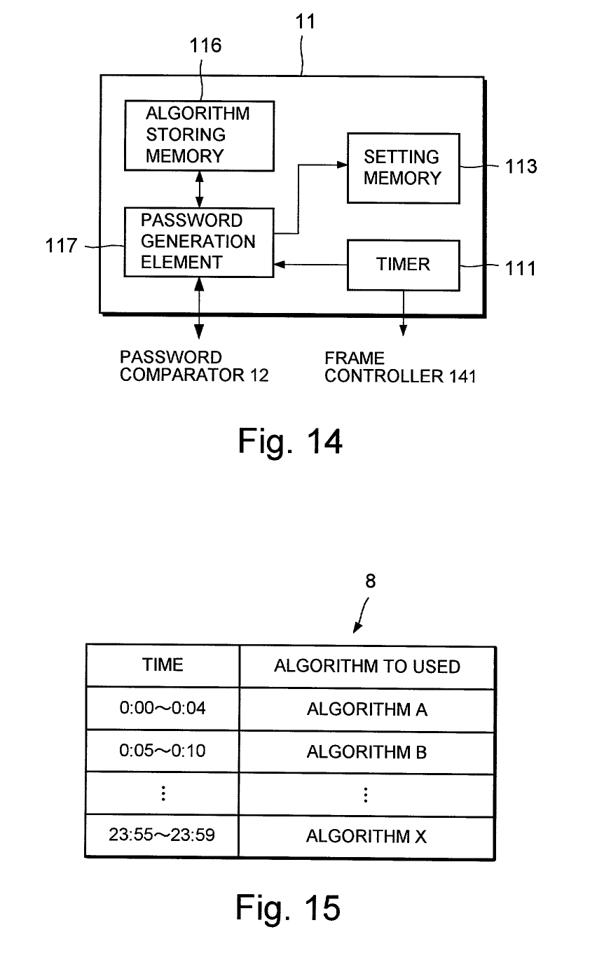

Referring to FIG. 14, the password controller 11 in the third embodiment is provided with an algorithm storing memory 116 storing a plurality of password generation algorithms instead of the password storing memory 112 storing the plurality of passwords. Furthermore, the password controller 11 is provided with a password generation element 117 which reads out one password generation algorithm from the algorithm storing memory 116 to generate a password, instead of the password selector 114. Still furthermore, setting information 8 for regulating a time at which the password generation algorithm is used by the password generation element 117 is held in the setting memory 113, as shown in FIG. 15.

Note that as the password generation algorithms, an equation according to general mathematics using a time (for example “minute”) as a parameter may be satisfactorily utilized.

An operation of the password controller 11 in the third embodiment of the present invention will be hereinafter described with reference to the drawings. Note that the plurality of password generation algorithms shall be equations using a time (minute) as a parameter, respectively.

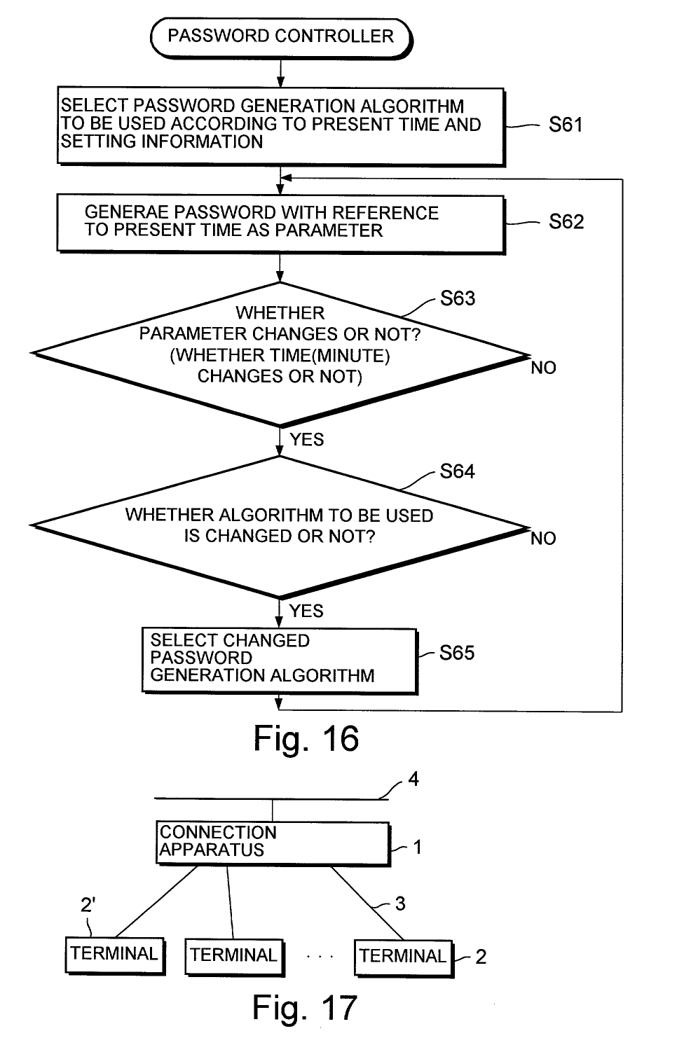

Referring to FIGS. 14 and 16, the password generation element 117 first refers to the present time represented by the timer 111 and the setting information 8 of the setting memory 113, and selects a password generation algorithm to be used from the algorithm storing memory 116 (S61). The password generation element 117 uses the selected password generation algorithm, and generates a password with reference to the present time of the timer 111 as a parameter (S62). Thereafter, when the parameter changes, that is, when a time (minute) changes (S63), the password generation circuit 117 confirms by referring to the setting information 8 whether the algorithm to be used is changed or not (S64). If the algorithm to be used is changed, the password generation element 117 selects the changed password generation algorithm from the algorithm storing memory 116 (S65), and generates a password with reference to the present time as a parameter (to S62). On the other hand, if the algorithm to be used is not changed, the password generation element 117 regenerates a password by use of a new parameter (time) (to S62).

Furthermore, a constitution in which a time, when the password is generated, is added to the frame as the password generation time instead of the password selection time shown in the second embodiment may be adopted in the third embodiment.

As described above, in the present invention, when each terminal 2 is connected to the connection apparatus 1, the terminals 2 and the connection apparatus 1 are synchronized with each other in terms of time, and the password changes in accordance with time. Accordingly, if each terminal 2 is legal one having the same passwords (or the same algorithms) and the setting information as those of the connection apparatus 1, each terminal 2 can change the password similarly to the connection apparatus 1, even if the connection apparatus 1 changes the password with passage of time. As a result, it is possible to proceed the communication by use of a different password in accordance with setting information stored in the setting memories 113 and 114. On the contrary, when the communication is performed by use of a password acquired illegally, the password comparator 12 detects the disagreement of the passwords by the change of the connection apparatus 1 accompanied with the passage of time, and illegal access can be found out.

As apparent from the above descriptions, according to the present invention, a frame of a terminal which cannot transmit a correct password included in the frame is abandoned in a connection apparatus. Accordingly, a communication of an illegal terminal with other terminals is not established, and it will be possible to keep a high network security. Since a password is changed with passage of time, even when the password is stolen at one point by an analyzer or the like (or the password is unscrambled at one point), it is possible to prevent that the communication is continuously performed through the connection apparatus by the stolen (or unscrambled) password.

While the present invention and its advantages have been described in conjunction with preferred embodiments in the above detailed descriptions, the present invention is not limited thereto, and various changes, substitutions and alternations can be made therein without departing from spirits and scope of the inventions as defined by the appended claims.

What is claimed is:

1. A terminal certification system comprising:
a plurality of terminals; and
a connection apparatus connected to said terminals,
wherein said connection apparatus and said plurality of terminals each includes a password controller which changes a password according to passage of time, and
wherein when said terminal tries to communicate with another terminal, said connection apparatus permits the communication if a password generated by the password controller of said terminal is in agreement with a password generated by the password controller of said connection apparatus.

2. The terminal certification system according to claim 1,
wherein said connection apparatus further includes:
a frame transfer processing element which performs transmission/receipt of a frame to/from said network;
a plurality of interfaces connected to said terminals, respectively; and
a password comparator which compares a password added to the frame transmitted from said each terminal with the password selected by said password controller of said connection apparatus, and
wherein when said password comparator shows an agreement of the passwords, said interface transfers the corresponding frame to said frame transfer processing element, and when said password comparator shows a disagreement of the passwords, said interface abandons the corresponding frame.

3. The terminal certification system according to claim 1,
wherein said password controller includes:
a password storing memory which stores a plurality of passwords; and
a password selector which selects one of the plurality of passwords stored in the password storing memory, and
wherein said password selector changes a selection of the password according to passage of time.

4. The terminal certification system according to claim 3,
wherein said password controller further includes:
a timer; and
a setting memory which stores setting information indicating which password is to be used depending on time, and
wherein when the terminal is connected to said connection apparatus, said timer of said password controller of said terminal is made to be synchronized with said timer of said password controller of said connection apparatus, and said password selector changes the selection of the password in accordance with a time represented by said timer and said setting information.

5. The terminal certification system according to claim 4,
wherein each of said plurality of terminals further includes:
a frame transmission/receipt element which controls transmission/receipt of the frame to/from said connection apparatus, and
a frame assembly element which receives a password from said password controller and adds the password to the frame when the frame is transmitted to said connection apparatus.

6. The terminal certification system according to claim 5,
wherein said frame assembly element further receives a password selection time from said password controller, and adds the password and the password selection time to a frame to be transmitted to said connection apparatus.

7. The terminal certification system according to claim 6,
wherein the password controller of said connection apparatus further includes an effective time storing memory which stores a predetermined effective time, and
wherein if a difference between a time represented by said timer and said password selection time is within the effective time, said password selector selects a password to be used, based on said password selection time and said setting information, and if the difference between the time represented by said timer and said password selection time is equal to the effective time or more, said password selection sector a password to be used, based on the time represented by said timer of said connection apparatus and said setting information.

8. The terminal certification system according to claim 1,
wherein said password controller includes:
an algorithm storing memory which stores a plurality of password generation algorithms; and
a password generation element which selects one of said plurality of password generation algorithms stored in the algorithm storing memory, and which generates a password with the selected password generation algorithm, and
wherein said password generation element changes the password generation algorithm in accordance with passage of time, and generates a password.

9. The terminal certification system according to claim 8,
wherein said password controller further includes:
a timer; and
a setting memory which stores setting information indicating which password generation algorithm is used depending time, and
wherein said timer of said password controller of said terminal is made to be synchronized with said timer of said password controller of said connection apparatus when said terminal is connected to said connection apparatus, and said password generation element selects a password generation algorithm in accordance with a time represented by said timer and said setting information, thus generating a password.

10. The terminal certification system according to claim 8,
wherein each of said plurality of password generation algorithms generates a different password in accordance with the time represented by said timer.

11. A method of certifying a terminal comprising:
synchronizing times of a connection apparatus and said terminal with each other;
selecting a password in accordance with a time of said terminal;
adding the password to a frame to be transmitted;
transmitting the frame added the password from said terminal to said connection apparatus;
comparing the password which is added to the transmitted frame with a password selected in accordance with the time of said connection apparatus; and
permitting the transmission of the frame if said two passwords are in agreement with each other, and prohibiting the transmission of the frame and abandoning the frame if said two passwords are not in agreement with each other.

12. The method according to claim 11,
wherein said selecting step selects one of a plurality of password generation algorithms in accordance with a time of said terminal, and generates a password based on the selected password generation algorithm; and
said comparing step compares the password added to the transmitted frame with a password generated by one of a plurality of password generation algorithms in said connection apparatus selected in accordance with the time of said connection apparatus.

13. The method according to claim 11,
wherein said adding step further adds a selection time, at which said password is selected, to a frame to be transmitted; and
said comparing step compares the password which is added to the transmitted frame with a password selected in said connection apparatus depending on said selection time added to the transmitted frame.

14. The method according to claim 13, wherein
said selecting step selects one of a plurality of password generation algorithms in accordance with a time of said terminal, and generates a password based on the selected password generation algorithm;
said adding step adds the password and a selection time, at which said password is generated, to a frame to be transmitted; and
said comparing step compares the password added to the transmitted frame with a password generated by one of a plurality of password generation algorithms in said connection apparatus selected in accordance with said selection time added to the transmitted frame.

15. A connection apparatus connected to a plurality of terminals comprising:
a password controller which changes a password according to passage of time; and
a password comparator which compares a password added to a frame sent from one of said plurality of terminals with a password generated by said password controller,
wherein when a frame is sent from one of said plurality of terminals, said connection apparatus permits the transmission of the frame if said password comparator indicates that the password of the frame and the password generated by said password controller are in agreement with each other.

16. The connection apparatus according to claim 15,
wherein said password controller includes:
a password storing memory which stores a plurality of passwords; and
a password selector which selects one of the plurality of passwords stored in the password storing memory, and
wherein said password selector changes a selection of the password according to passage of time.
